(19) United States
(12) Patent Application Publication
(10) Pub. No.: US 2007/0098038 A1
(43) Pub. Date: May 3, 2007

(54) Radiator cap with a thermometer

(76) Inventor: Louis Carroll, Perris, CA (US)

Correspondence Address: Louis Carroll, 363 West 3rd Street, Perris, CA, 92570, US

(21) Appl. No.: 11/259,685

(22) Filed: Oct. 27, 2005

(51) Int. Cl. G01K 5/00; G01K 1/14

(52) U.S. Cl. 374/146; 374/206

(57) ABSTRACT

A radiator cap for closing the filler neck of a vehicle cooling system. Included in this cap is the conventional function of being able to automatically release the pressure of the engines cooling system, when said pressure overrides the radiator caps valve assembly. Also included is the conventional function of being able to allow the reclamation of coolant from an external container, when the atmospheric pressure exceeds the pressure inside the engines cooling system. This invention includes a painted numerical display embedded in the top surface of the cap. A temperature probe extends from the bottom surface of the cap and is mechanically connected to the needle indicator, mounted over the painted numerical display. Upon securing the cap to the filler neck, the temperature probe senses the temperature of the associated cooling system, this information is mechanically delivered to the needle indicator, which will correspond to certain calibrated numbers on a painted display, to be read by the user. The cap enables a user to ascertain the cooling system temperature at the filler neck site efficiently, and reliably.

### BACKGROUND OF THE INVENTION

This invention relates to the field of automotive parts, and is a radiator cap. More particularly, it is a cap that provides the instantaneous display of the temperature at the filler neck of the vehicle's cooling system.

Various radiator caps have been devised so as to relieve the pressure within the cooling system to allow for the safe removal of the radiator cap. A coolant temperature gauge provided on the dashboard of the vehicle for driver viewing is also known. These devices do not allow the vehicle operator to quickly, accurately and efficiently check the temperature of the coolant, at the filler neck of the vehicles cooling system, i.e. radiator.

From a safety standpoint, it is important to know the temperature of the coolant prior to cap removal, to help prevent escaping hot steam from spraying upon the vehicle's user. A dash mounted temperature gauge does not efficiently address this desire because it is usually situated within the vehicle, and is only operating when the engine is running. The user, prior to removing the cap, might not take the time to start the engine and wait for the temperature gauge to properly register the coolant temperature. Additionally, a typical dash mounted gauge is not always calibrated with numbers. Therefore, it may not be possible to ascertain the actual temperature of the coolant. It is therefore desirable to have a radiator cap that indicates the temperature of the coolant with calibrated numbers, at the filler neck of the cooling system, without the need for vehicle start-up.

In response thereto, I have invented a radiator cap equipped with a descending temperature probe for extension into the cooling system upon cap installation onto the radiator. The cap has a numbered readout on the exterior surface in mechanical communication with the probe.

It is an object of this cap invention to: 1) indicate the temperature of the cooling system, 2) allow for removal of the cap for adding coolant to the vehicles cooling system, 3) provide a predetermined superatmospheric pressure to the coolant to increase the efficiency of the cooling system, 4) provide a cap which needs no modification of the cooling system prior to use. Other objects and advantages will become apparent from the following description taken in connection with the accompanying drawings, wherein is set forth by way of illustration and example, an embodiment of this invention.

### BRIEF SUMMARY OF THE INVENTION

The radiator cap invention described herein is called “ThermoCap”. This cap is equipped with a numbered and calibrated temperature display background with a visible rotating needle which points to the correct temperature number. The rotating needle is directly connected to the temperature probe, which descends into the cooling system at the radiators filler neck. Like current existing radiator caps, ThermoCap is equipped with a spring pre-loaded valve that provides for extra positive pressure within the cooling system, when installed. Also like current existing radiator caps, ThermoCap is equipped with a return-valve that allows for coolant reclamation from an external coolant bottle, during cases of negative pressure within the cooling system.

It is important to know the temperature of the coolant in the cooling system, prior to cap removal, to prevent the possibility of hot coolant spraying upon the vehicles user. ThermoCap addresses this need by indicating the temperature of the coolant in the fahrenheit scale and celsius scale. The method of communication between the rotating needle indicator, and the temperature probe is mechanical, thus eliminating the need for electricity or other complicated means.

As with other typical radiator caps, ThermoCap is easily removable from the cooling systems radiator, so as to allow for coolant filling.

### BRIEF DESCRIPTION OF THE DRAWINGS

FIG. 1 is a perspective view of the radiator cap with the temperature probe showing at the bottom.

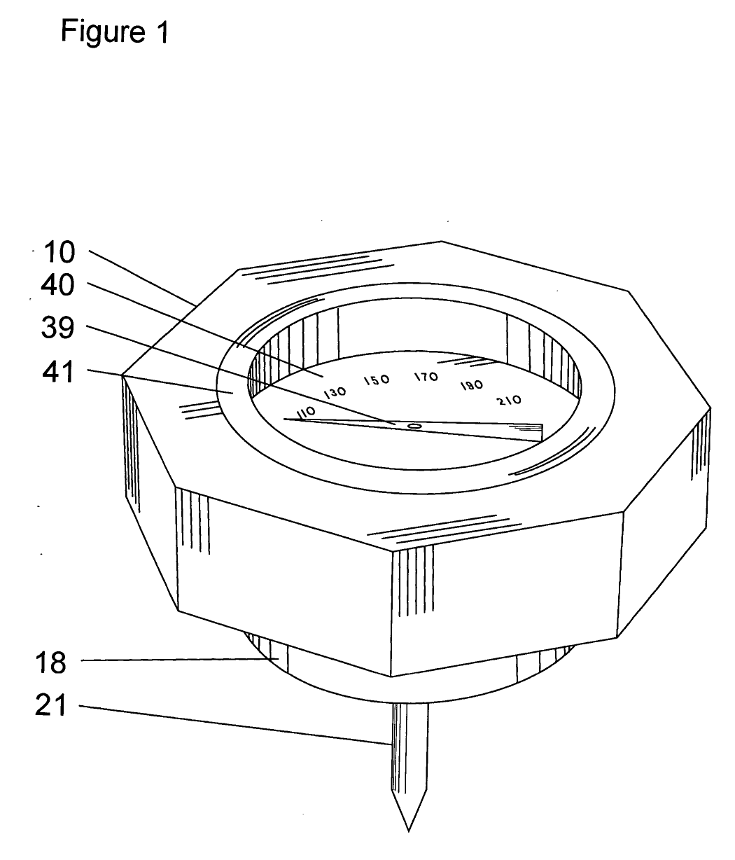

FIG. 2 is a top view of the radiator cap showing the numbered meter face and indicator needle.

FIG. 3 is a side view of the radiator cap.

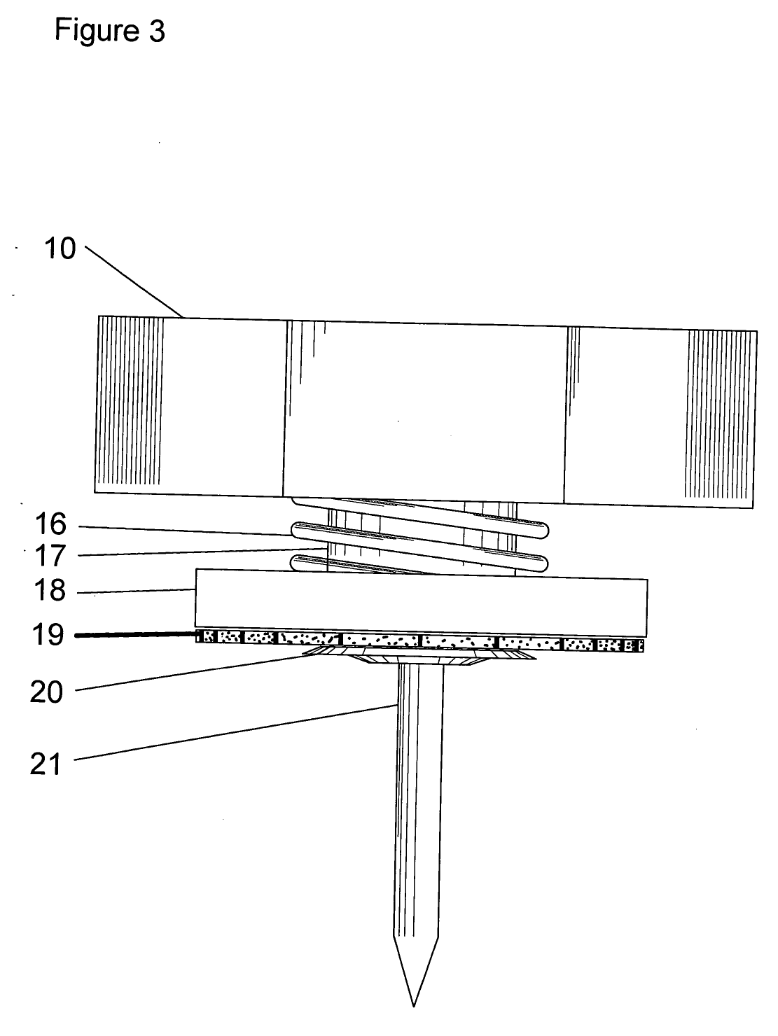

FIG. 4 is a cross sectional view of the radiator cap

### DETAILED DESCRIPTION OF THE INVENTION

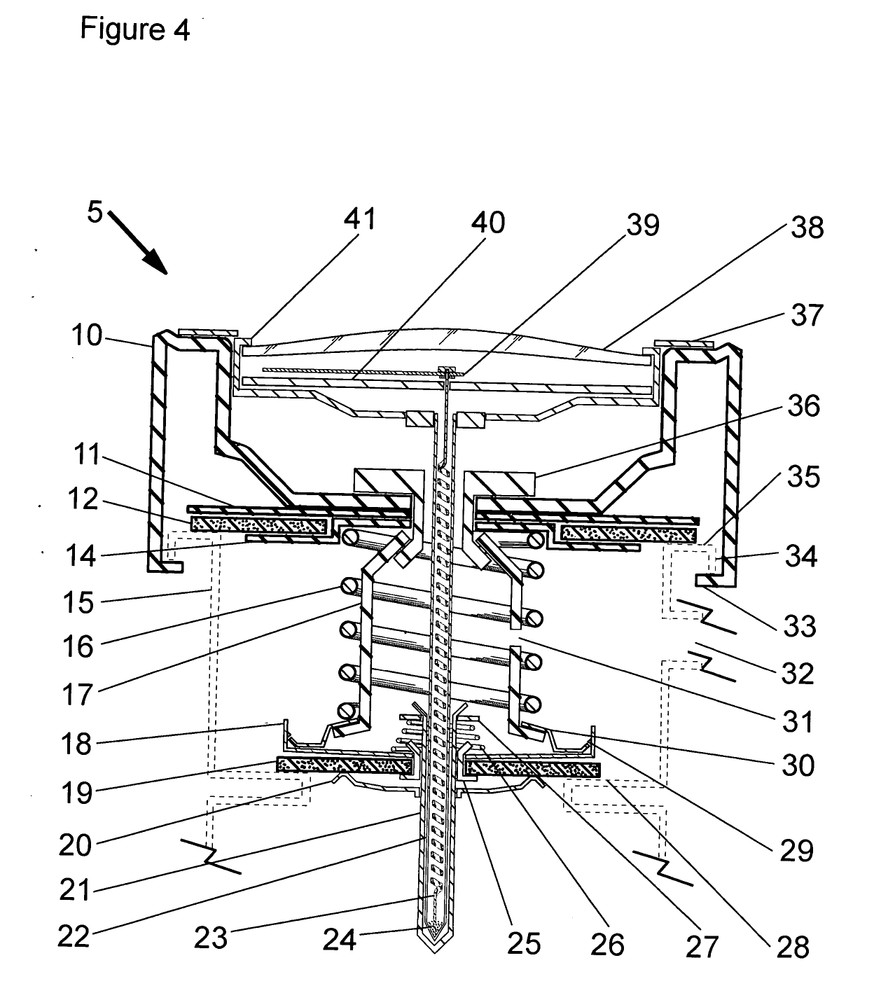

Referring now to FIG. 4, the radiator cap 5 is shown installed on a conventional radiator filler neck 15. The cap 10 includes a manually manipulable crown or shell 10 covering the filler neck 15. The crown 10 has a pair of oppositely opposed cam fingers 33 which pass through corresponding openings (not shown) in the filler neck 15 and engage the lip 34 of the filler neck 15 when the crown 10 is rotated onto the filler neck 15 to thereby securing the cap 5 to the filler neck 15.

The crown 10 has a center aperture with which a rivet 36 is employed to secure the seal support disk 11, seal retainer disk 14 and bell housing 17, by way of a flared lip at the bottom of the rivet 36. The upper rubber ring seal 12 is retained in position by the seal retainer disk 14. When the cap 5 is secured to the filler neck 15, the rubber ring seal is pressed upon the upper surface 35 of the filler neck 15, thereby preventing coolant from escaping from the cooling system, unless the cap 5 is removed from the filler neck 15.

Moving downward in FIG. 4, the bellhousing 17 centers and retains a valve spring 16. Valve spring 16 applies pressure to the lower seal support flange retainer 30. The lower seal support flange 18 is retained onto the lower seal support flange retainer 30 by way of four equally spaced small indentations 29. The force from the valve spring 16 is transferred through the lower seal support flange retainer 30 to the lower seal support flange 18. The lower seal support flange 18 then transfers the said pressure to the lower rubber ring seal 19. The lower rubber seal is pressed upon the top surface of the lower annular valve seat 28 of the filler neck 15, and thus provides a seal or separation between the pressure inside the cooling system (not shown) and the atmospheric pressure. The lower seal support flange 18, lower rubber ring seal 19 are retained by way of a rivet 25 with a center aperture. The water reclamation valve 20 is tightly attached to the temperature probe cover 21. The temperature probe cover 21 is situated through the aperture of the rivet 25 and is able to move slightly up or down along the axis of the temperature probe 22. The water reclamation valve spring 26 applies force between the top surface of the lower seal support flange 18, and a small washer 17, which in turn has been secured onto the top of the temperature probe cover 21 by flaring the top portion of the temperature probe cover 21. The normal position of the temperature probe cover 21 and the water reclamation valve 20 is such that the water reclamation valve is pressed against the lower rubber ring seal 19, under the force provided by the small water reclamation valve spring 26 and any existing superatmospheric pressure from the inside of the cooling system.

From it's seated and sealed position, the water reclamation valve can move in a downward fashion is cases where atmospheric pressure exceeds the pressure inside the cooling system. In a typical cooling system, an plastic water reclamation bottle is usually present outside the radiator, and water pass from the water reclamation bottle, through an opening 32 in the water filler neck 15. This water or coolant can then further pass through the opening 31 in the bell housing 17. The water or coolant can then pass through the small space between the center aperture of the lower rivet 25, and the temperature probe cover 21, finding it's way back into the radiator. Once the pressure between the inside of the cooling system, and atmospheric pressure is equalized, the water reclamation valve 20 will close under the pressure of the water reclamation valve spring 26.

A typical bi-metal thermometer is used to read the temperature of the cooling system. Referring to FIG. 4 again, we have a basic bi-metal thermometer consisting of a temperature probe 21, being secured to a gauge housing 41. Inside the temperature probe is a long coiled bi-metal strip 23. This bi-metal strip 23 employs two different strips of metal, bound to each other and wound in a circular fashion many times. The bi-metal strip 23 employs two different types of metal, and each type of metal has a slightly different rate of expansion or contraction when heated or cooled. As the temperature of the temperature probe 22 changes, the bi-metal strip 23 will coil tighter or uncoil in response to the change in temperature. This coiling or uncoiling of the bi-metal strip 23 is indicated by the position of the needle indicator 39. The lower end of this bi-metal strip 23 is adhered to the bottom of the temperature probe 21 using a suitable adhesive 24 compatible with metal. The top end of the bi-metal strip 23 passes through a small aperture in the meter face 40, and is directly connected to the needle indicator 39. The needle indicator 39 is able to rotate according to the motion of the bi-metal strip 23, and indicate the temperature of the coolant, by pointing to the corresponding calibrated numbers painted on the meter face 40. The meter face is protected from environmental debris by means of a glass cover 38

Lastly, in FIG. 4, there is a non-essential colored trim piece 37 attached to the top of the cap crown 10 by means of two opposite rivets (not shown). The reason for the addition of the trim piece is purely aesthetic.

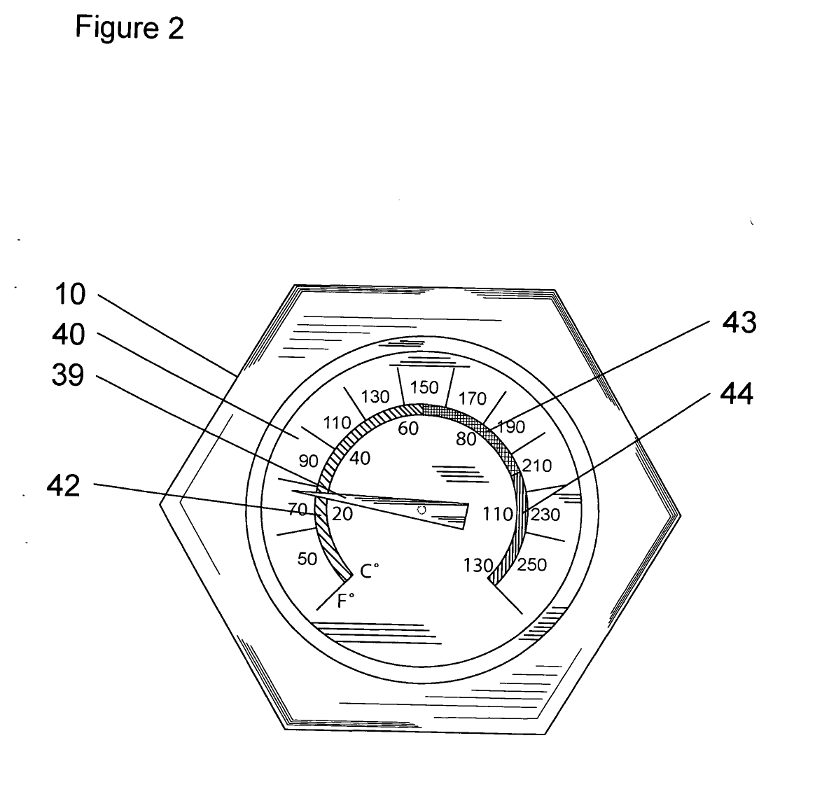

Referring now to FIG. 2, I have included a color coded section on the meter face 40 to indicate the temperature severity of the cooling system. There is a thin semi-circular strip of paint corresponding to the color green 42, which would indicate a relatively safe condition to remove the radiator cap. Then there is another semi-circular strip of paint corresponding to the color yellow 43, which would indicate an unsafe condition for removing the radiator cap. Lastly, there is another semi-circular strip of paint corresponding to the color red 44, which would indicate a very hazardous condition for removing the radiator cap.

While I have described herein a preferred embodiment of the present invention, it is to be under stood that changes and modifications can be made without departing from the true scope and spirit of the present invention. This true scope and spirit are defined by the my claims and their equivalents, to be interpreted in light of the foregoing specification.

Having thus described the invention, what is claimed as new and desired to be secured by Letters Patent is as follows:

1. In combination with a filler neck of a vehicle's engine cooling system positioned under a normally closed hood of a vehicle, a closure device for the neck comprising:
a cap having upper and lower surfaces for covering an open end of the filler neck;
means for releasably securing said cap to the filler neck;
means for releasing pressure from the cooling system by way of spring loaded valve means for allowing coolant to be reclaimed by the cooling system by way of a spring loaded valve a mechanical temperature sensor assembly in said cap, said assembly including a temperature probe extending from the gauge housing of said cap for extension through the filler neck and into the engine's cooling system upon said securing of said cap thereto;
a indicator needle in direct mechanical communication with said temperature probe and positioned in said upper surface of said cap over the meter face, which continuously indicates the temperature of the environment inside the engine's cooling system.

2. The combination as claimed in claim 1 wherein said mechanical communication between the indicator needle and temperature probe is by means of a common coiled bi-metal strip.
